(19) United States
(12) Patent Application Publication
(10) Pub. No.: US 2005/0104678 A1
(43) Pub. Date: May 19, 2005

(54) System and method for noise mitigation in high speed printed circuit boards using electromagnetic bandgap structures

(76) Inventors: Shahrooz Shahparnia, Hyattsville, MD (US); Omar M. Ramahi, Bethesda, MD (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/937,251

(22) Filed: Sep. 10, 2004

Related U.S. Application Data
(60) Provisional application No. 60/502,059, filed on Sep. 11, 2003.
(60) Provisional application No. 60/511,843, filed on Oct. 16, 2003.

(51) Int. Cl. H04B 3/28

(52) U.S. Cl. 333/12

(57) ABSTRACT

Electromagnetic Bandgap (EBG) structures are embedded between adjacent power planes in a multi-layer PCB to decrease the emanation of Electromagnetic radiation induced by power buses, signal layers, as well as to suppress the switching noise. EBG stages with different stop bands are cascaded to create rejection over a wider frequency region. The cascading can be performed in series, or may be formed in a variety of arrangements such as a checkerboard design or concentric ribbons positioned along the perimeter of the PCB. Each EBG stage is composed of conductive patches and via posts extending from each patch, which are positioned at a predetermined distance from each other. By surrounding the source of the noise with EBG stages, a sufficient suppression of electromagnetic noise over specific frequency bands of interest is achieved.

### REFERENCE TO RELATED APPLICATIONS

This patent application is based on Provisional Patent Application No. 60/502,059 filed Sep. 11, 2003, and Provisional Patent Application No. 60/511,843 filed Oct. 16, 2003.

### FIELD OF THE INVENTION

The present invention relates to suppression of electromagnetic noise. In particular, this invention relates to the mitigation of electromagnetic radiation in electronic packaging, including printed circuit boards (PCBs).

In overall concept, the present invention relates to the application of Electromagnetic Bandgap (EBG) structures for reduction of electromagnetic radiation induced by power buses as well as by signal layers in the printed circuit boards.

The present invention further relates to mitigation of simultaneous switching noises (SSN) in printed circuit boards by embedding EBG structures in the PCBs and more particularly, by cascading EBG stages with different stop bands to attain suppression of the noise over an ultrawide frequency bandwidth.

Additionally, the present invention relates to specific topology of the EBG structures embedded in the printed circuit boards for suppression of unwanted wave propagation as well as SSN mitigation, and for isolation between different portions of circuits.

### BACKGROUND OF THE INVENTION

Electromagnetic radiation of high-speed digital and analog circuits is considered one of the most critical challenges to the electromagnetic interference, compatibility and reliability of electronic systems. The continuous decrease in power supply and threshold voltage levels in CMOS based digital circuits increases their vulnerability to external electromagnetic interference. Simultaneously, increases in clock and bus speeds increases the potential of the circuit to radiate, thus compromising its compatibility potential and also increasing its security vulnerability. Switching noise has become one of the major concerns for EMC engineers in modern designs.

Electromagnetic interference is a complex mechanism that takes place at a number of levels including the chassis, board, component, and finally, the device level. Radiation sources typically include trace coupling, cables attached to the boards, components such as chip packages and heat sinks, power busses and other elements that may provide a low impedance current path. As the speed of modern high-performance digital circuits rapidly increases, there is a corresponding energy consumption increase. The energy required is often provided by power planes embedded in the multilayer structure of the board. In printed circuit boards (PCBs) these power planes induce radiation by a time-varying fringing electric field at the edges of the board. Mitigation of the electromagnetic noise follows certain modalities and strategies that depend directly on physical topology and material. The most traditional approach to mitigate electromagnetic noise is through hardening, variation of topology, variation of material, or through alternate electronic circuitry design techniques which often necessitates the use of additional circuitry components. Although appropriate shielding may generally be achieved, the consequent cost may be significant especially in a number of electronic systems that are cost-sensitive. Thus, new noise mitigation paradigms are becoming more relevant and necessary in the current area of expanding technology.

Fast switching in digital circuits that use standard printed circuit board (PCB) technology creates simultaneous switching noise (SSN) which is sometimes commonly referred to as ground bounce or Delta-I noise. Switching noise if left unchecked, may produce several low and high-frequency anomalies. The most important of these anomalies is the biasing of the power planes that leads to logic errors in digital circuits. In fact SSN is considered by many in the field to be one of the bottlenecks in the design of high-speed PCB and packages. Therefore with the ever increasing clock speed of digital circuits the suppression of this noise becomes technologically important.

Switching noise is generally caused by the high-speed time-varying currents needed by high-performance digital circuits. The flow of these currents through vias between layers of a printed circuit boards causes radiation efflux. The radiated waves use the parallel plates created by the power planes to propagate. Simultaneous Switching Noise (SSN) is an inductive noise created when many outputs of a digital circuit switch at the same time. SSN cannot be quantified in precise measure due to its dependence on the geometry of the board and current paths. A simplified way of describing SSN is by considering the following equation:

$${V}_{noise} = {NL}_{eq} \frac{di}{dt} \qquad ( 1 )$$

where Vₙₒᵢₛₑ is the magnitude of the noise voltage, N is the number of outputs (drivers) switching simultaneously, L_{eq} is the equivalent inductance through which the current must pass and i is the current that passes through each driver during a switching operation. When several signals switch simultaneously the power planes connected to the power supply must deliver the required current which has to pass through L_{eq}. The existence of inductance in the path of the current introduces voltage fluctuations on power planes which affects the outputs of the drivers as well as other signals throughout the board. This has been found to create malfunctions and false switching leading to system breakdown. This type of noise is considered a fundamental and critical problem in the design of high-speed printed circuit boards.

The continuous and rapid increase of clock frequency is another source for switching noise. In fact, high-speed small currents may have the equivalent impact on switching noise as is found in switching of circuits that involve large amounts of current (simultaneous switching). FIG. 1 shows a general schematic diagram for the generation of switching noise within a power bus of a PCB. A high-speed or high-power (or both) logic gate that consumes power from two parallel power planes is a first source of noise. A via that passes through these planes and is not necessarily connected to any of them is another source of noise.

Electromagnetic waves generated by these sources of noise use parallel-plates to propagate and therefore induce noise on other signals passing through the power bus (vias) and eventually radiating from the edges of the board.

Different techniques have been proposed to mitigate the SSN. These techniques are centered on the addition of decoupling capacitance that is intended to create low impedance path at higher frequencies. Both discrete decoupling capacitors, and embedded capacitance, have been used but only with limited success. Decoupling capacitors have limited effect on SSN due to their finite lead inductance and, in general, these capacitors are not effective at frequencies higher than 500 MHz. Embedded capacitance techniques, on the other hand, are still in the development stage and may be impractical due to presently excessive costs.

In their recent work, Kamgaing and Ramahi introduced the use of electromagnetic bandgap structures to mitigate SSN (T. Kamgaing and O. M. Ramahi, “A novel power plane with integrated simultaneous switching noise mitigation capability using high impedance surface,” IEEE Microwave and Wireless Components Letters, Vol. 13, No. 1, pp. 21-23, January 2003). A similar concept was also introduced in (R. Abhari and G. V. Eleftheriades, “Metallo-dielectric electromagnetic bandgap structures for suppression and isolation of the parallel-plate noise in high-speed circuits” , IEEE Transactions on Microwave Theory and Techniques, Vol. 51, No. 6, pp. 1629-1639, June 2003). The SSN is suppressed by the introduction of an HIS between the power planes of the circuit board.

In Kamgaing and Ramahi, a bandgap of 3.3 GHz was achieved by using a combination of an inductance-enhanced HIS with a wall of RC pairs. While in Abhari and Eleftheriades, a bandgap of 2.2 GHz was achieved by using a double-mushroom structure and a bandgap of 3.3 GHz using a single-mushroom structure at a higher frequency. These two recent works, while introducing the concept of suppression of SSN using an electromagnetic bandgap structure have suffered from two important drawbacks. The first drawback is related to manufacturing cost. In both of these prior art systems, the new power plane structure has a total of four layers instead of the typical two. This leads to a substantial increase in fabrication cost. The second drawback is related to performance since a relatively short band gap has been achieved. This is capable of suppressing the dominant harmonic but not successive higher-order harmonics. It would be highly desirable to have a noise suppressing mechanism which eliminates these two critical drawbacks.

### SUMMARY OF THE INVENTION

It is an object of the present invention to provide a technique for mitigation of Electromagnetic Interference in electronic packaging structures, for example, printed circuit boards, including switching noise reduction by means of electromagnetic bandgap (EBG) structures which are embedded in the printed circuit boards (PCBs).

It is another object of the present invention to provide PCBs with suppressed electromagnetic radiation induced by the power bus or signal layer where metallo-dielectric Electromagnetic Bandgap (EBG) structures embedded into the PCB (EEBG) are arranged in a specific manner.

It is a further object of the present invention to provide a technique for mitigation of radiation from parallel-plate bus structures in high speed printed circuit boards caused by switching noise, by cascading EEBG stages with each having a predetermined distinct stop band filtering capability to suppress the noise over an ultra-wide frequency bandwidth.

It is a another object of the present invention to provide PCBs with reduced Electromagnetic Interference in which a ribbon consisting of EEBG structures is located in surrounding relationship with the source of electromagnetic radiation and may be placed along the perimeter of the PCB between the power planes (or signal layers) of the PCB to eliminate the electromagnetic radiation emanating from the edges of the PCB.

It is a further object of the present invention to provide a technique for reduction of the noise in printed circuit boards with mitigated wave propagation between the plates of the power bus (or signal layers) in which the concentric ribbons consisting of EEBG structures are cascaded to suppress the unwanted wave propagation in ultrawide bandwidths.

It is also an object of the present invention to provide a technique for isolation between different portions of circuits, such as, for example, analog and digital parts, by using EEBG structures.

The present invention is additionally directed to a method for mitigation of electromagnetic radiation generated in electronic packaging, such as a multi-layer structure, with at least two conductive planes separated from each other where the wave propagation (electromagnetic radiation) is to be reduced between the conductive planes. In accordance with such a method, at least one EEBG stage of a predetermined filtering capability is embedded in the electronic packaging, for example, the PCB between the conductive planes in surrounding relationship with the source of electromagnetic radiation in order to attenuate the propagation of the waves and to suppress the electromagnetic radiation from the edges of the multi-layer structure (printed circuit board).

To mitigate the electromagnetic radiation in the ultrawide bandwidth, several EEBG stages, each having a distinct stop-band filtering capability, are cascaded. When placed on the path of the wave propagation, this substantially eliminates or significantly reduce the unwanted electromagnetic noise.

One possible configuration is one in which each EEBG (Embedded Electromagnetic Bandgap) stage is a structure which includes conductive patches (of a hexagonal, rectangular, spiral, etc. shape) with via posts extending from a center portion of the patches. The stop band filtering capability of each EEBG stage may be adjusted by changing the number of the EEBG patches, and/or changing the shape and size of the patches as well as a distance therebetween.

The EEBG stages, in order to provide a substantial reduction of the Electromagnetic Interference, and/or of the switching noise, are embedded in the PCB in surrounding relationship with the source of the electromagnetic radiation. In preferred embodiments, the EEBG stage is positioned along the perimeter of the PCB to stop the radiation emitted from the edges of the PCB. The EEBG stage may be formed as a ribbon consisting of several rows of the patches with the via posts associated therewith. This EEBG ribbon is placed on one of the layers of the multi-layer PCB which preferably has a power plane (or a signal layer) thereon so that the distal ends of the via posts are coupled to one of the power planes (or signal layers). This patch layer is attached to another layer of the multi-layer PCB containing a power plane. In this manner, the EEBG structure is embedded in the PCB between the power planes (or signal layers).

In a cascaded arrangement, several, a plurality of EEBG ribbons (each comprised of a predetermined number of the rows of the patches of a predetermined shape, and size, with the associated vias) are positioned along the perimeter of the PCB in concentric relationship with each other and cascaded to provide suppression of the noise in a wide or ultrawide frequency bandwidth.

As another aspect, the present invention is directed to a multi-layer PCB structure with noise mitigation features. Such a multi-layer PCB includes conductive planes (power planes and/or signal layers). EBG structures are embedded in the PCB (thus forming Embedded Electromagnetic Bandgap structures EEBG) between at least two adjacent conductive planes and coupled to one of the conductive planes by via posts. Preferably EEBG structures of predetermined topology are provided for all pairs of power planes (or signal layers) in the PCB.

The EEBG stages are formed as periodic structures with each having a distinct filtering capability. Each EEBG stage includes a plurality of conductive patches with the via posts extending from a generally central location of the respective conductive patches. Each conductive patch has a specific contour, for instance, hexagonal, rectangular, etc., and a predetermined size. By controlling the size and shape, as well as the number of patches in each EEBG stage, in combination with controlling the distance between adjacent patches, an EEBG stage with specific filtering capabilities is fabricated. By cascading EEBG stages with distinct filtering capabilities, an overall EEBG structure is formed which is capable of mitigating electromagnetic noise in an ultrawide frequency bandwidth.

The EEBG stages may be arranged in different manners. For instance, they may be cascaded in series, or they may be formed as ribbons concentrically surrounding the source of radiation. Alternatively, the EEBG stages may be positioned within the PCB in a checkerboard manner, etc. For the purpose of electromagnetic noise interference (EMI) reduction of PCBs and packages, it is preferable that the EEBG stages are formed as ribbons positioned along the perimeter of the PCB. To cascade several ribbon EEBG stages, the EEBG ribbons of different filtering parameters are positioned along the perimeter of the PCB in concentric relationship each with the other.

The PCB with the noise suppressing capability may be formed by arranging the HIS stage (or stages) on one of the layers (patch layer) of the multi-layer printed circuit board so that the EEBG structures are connected by the via posts to the conductive plane (power bus or signal layer) on the patch layer of the PCB. The patch layer carrying the EEBG stage(s) is then attached to another layer of the PCB carrying the conductive plane, such as power plane and/or signal layer, and secured thereto by means known to those skilled in the art, such as, for example, adhesives, etc. The multi-layer PCBs with EEBG structures embedded therein have been found to provide significantly improved performance characteristics.

These features and advantages of the present invention will be fully understood and appreciated from the following detailed description of the invention in conjunction with the accompanying Drawings.

### BRIEF DESCRIPTION OF THE DRAWINGS

FIG. 1 is a prior art schematic representation of a switching noise generation mechanism induced by a power bus in a multi-layer printed circuit board;

FIG. 2A is a schematic representation of the lateral view of the PCB of the present invention which includes EEBG structures formed as a ribbon around the board (only two rows of the EEBG structures are shown);

FIG. 2B is a prospective view of the disassembled multi-layer PCB of FIG. 2A, showing the “patch layer” with the EEBG ribbon positioned along the perimeter thereof;

FIGS. 3A and 3B schematically represent an EBG structure embedded in a PCB;

FIG. 4 is a patch layer of the printed circuit board with a ribbon of four rows of EEBG structures positioned along the perimeter of the board;

FIG. 5 is a schematic representation of a cascaded EEBG structure (serially cascaded EEBG stages) for suppression of switching noise;

FIG. 6 is a diagram showing a measured S21 of fabricated PCB employing the cascaded EEBG configurations shown in FIG. 5;

FIG. 7 is a schematic diagram showing the principles of cascading two EEBG ribbons with different configurations for ultrawide band suppression of radiation from the edges of the PCB;

FIGS. 8A and 8B schematically illustrate the set-up for S-parameter simulation and experiments, where FIG. 8A shows a top view of the patch layer positioned between the SMA connectors, and FIG. 8B is a side view of the patch layer with the sources shown as a replacement for the SMA connectors;

FIG. 9 is a dispersion diagram for the EEBG structure fabricated on FR4 material with the patch size PS=5 mm, via diameter VD=0.8 mm, via length VL=1.54 mm, and the gap size GS=0.4 mm;

FIG. 10 is an S-parameters (S21) diagram for the EEBG structure with parameters corresponding to those of FIG. 9;

FIG. 11A shows the location of different test points in the experiments while measuring S21;

FIG. 11B shows an experimental set-up used for noise radiation measurements from the PCB;

FIGS. 12A-12D are diagrams showing measured S21 for the EEBG structure of FIG. 4 within a power bus configuration at the test points TP1, TP2, TP3, and TP4 respectively of FIG. 11A;

FIG. 13 is a diagram showing measured S21 for the structure of FIG. 7 within a power bus configuration at the test point TP5 of FIG. 11A;

FIG. 14 is a comparative diagram showing a frequency range of different radiation reduction methods; and

FIG. 15 shows a checkerboard design of the patch layer of the PCB with suppressed switching noise.

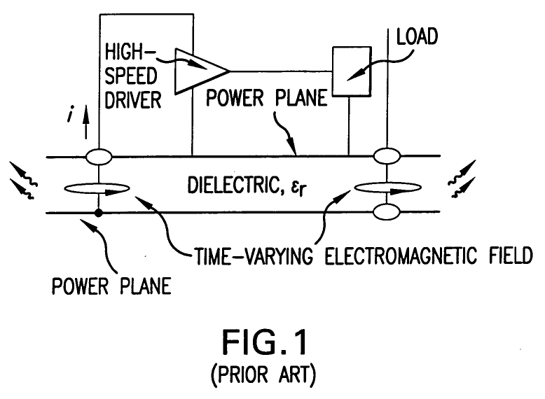

### DETAILED DESCRIPTION OF THE PREFERRED EMBODIMENTS

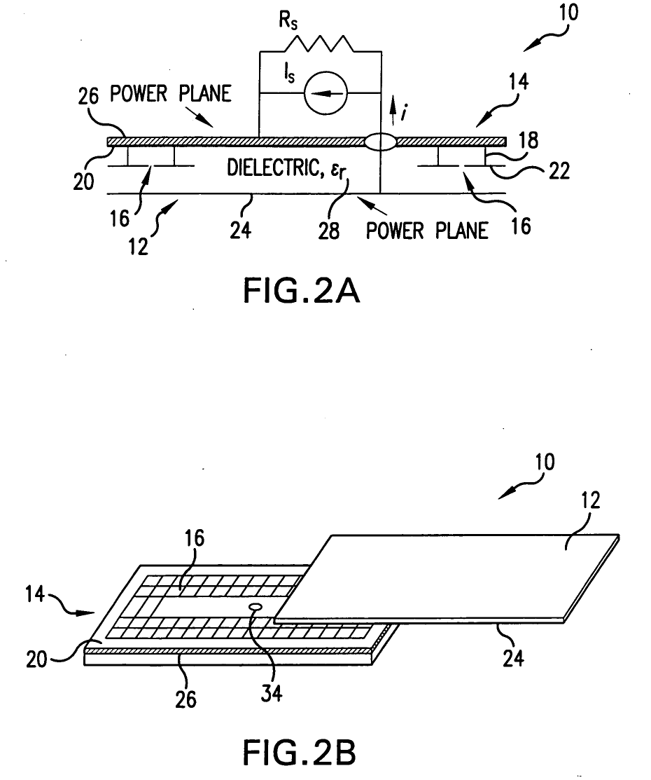

Referring now to FIGS. 2A and 2B, a multilayer PCB 10 includes a plurality of layers (boards), which can be implemented with commercial PCB technology. The PCB 10 includes boards 12 and 14, which has EBG structure 16 formed thereon which will be further referred to as a “patch layer” 14. It will be readily understood by those skilled in the art that the multilayer PCB 10 may include more than two boards. The 2-layer design of FIGS. 2A and 2B is chosen merely for the purpose of simplicity of explanation and not to limit the scope of the present invention. It will be understood by those skilled in the art, that printed circuit boards represent one specific kind of electronic packaging, and the scope of the present invention is not limited to PCBs but is applicable to all electronic packaging methods.

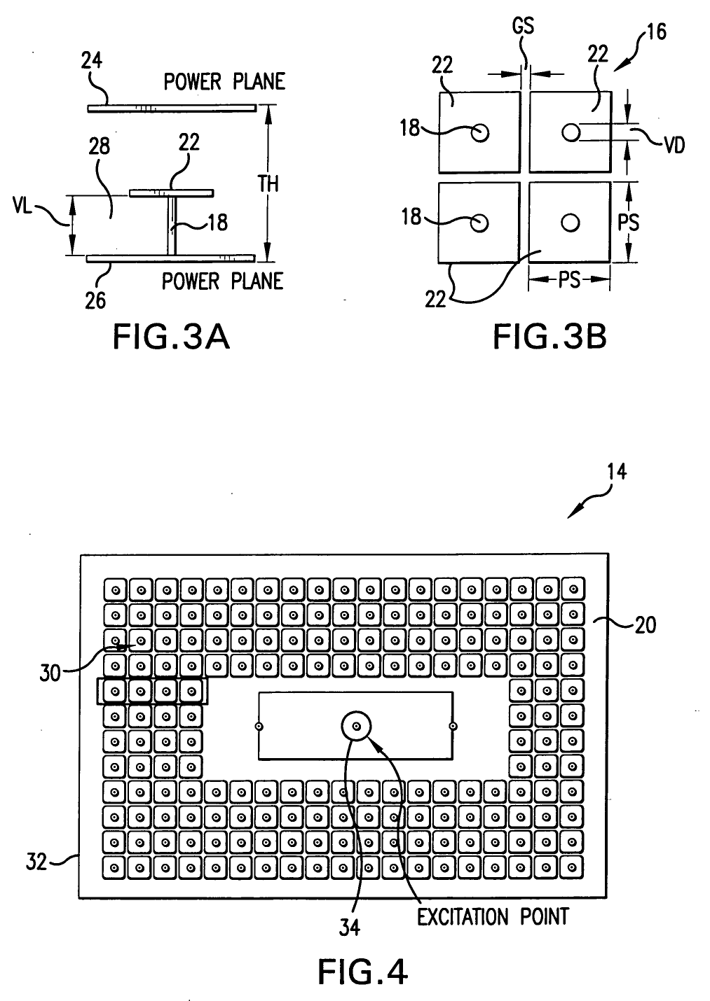

The Electro-magnetic Band-Gap (EBG) structure 16 is a structure that has an electromagnetic bandgap. The EBG structure 16 is a structure, which as shown in FIGS. 2A, 2B, and 3A, 3B, includes a via post 18 with a diameter size VD coupled to a conductive (metallic) surface 20 of the patch layer 14 in combination with a conductive (metallic) patch 22 on the top of each via post 18. The patches 22, each with a size denoted as PS in FIG. 3B, are separated by gaps of dimension GS from each other. Each patch 22 is displaced from the conductive surface 20 by a via post 18 of length VL. The structure 16 may be a periodic structure with a period (PS+GS) which is located between two parallel conductive (metallic) plates 24 and 26 which are displaced at the distance TH from each other. The plates 24 and 26 represent power planes or signal layers of the PCB 10. The entire EBG structure is an Embedded Electromagnetic Bandgap (EEBG) structure which acts as a band stop filter by suppressing surface waves within a predictable range of frequencies. This frequency range is a function of the geometrical features of the EEBG structure 16, such as periodicity, patch size, gap size, via diameter, via length, and board thickness, as well as the particular dielectric material 28 used in the printed circuit board 10 as the substrate. The EEBG used in the present Patent Application may be a periodic or not periodic structure, as long as it prevents the propagation of electromagnetic waves within a frequency range.

The patches may be contoured in different shapes, including, but not limited to, such shapes as squares, rectangles, spirals, crosses, hexagons, etc. The patches may be displaced the same distance from the top and bottom layers; or alternatively, the patches may be positioned at different distance from the top layer than from the bottom layer. The dielectric material 28 between the power planes may be uniform; or, alternatively, different materials may fill the space between the bottom layer and the patches and between the top layer and the patches. The frequency range may be controlled by changing the parameters of the EEBG presented supra.

The technique of the present invention is not limited to the suppression of noise of a particular nature, but can be extended to any wave propagation between the metallic plates 24 and 26, which may be either the power bus or a signal layer of the PCB 10. Although a PCB having only two boards with the EEBG structure therebetween is shown in FIGS. 2A, 2B, and 3A, it is to be understood that multi-layer PCBs may include more than two stacked boards. The EEBG structures may be located between all, or several adjacent conductive layers to serve the purpose of the noise reduction in multi-layer PCBs. Although the EEBG structures shown in FIGS. 2A, 2B, 3A are built as a three layer structure (2 power planes and one patch layer), other configurations are also possible. In fact, it is possible to create a 2 layer EBG structures by etching one of the power planes at the cost of power delivery degradation, or even created multilayer EEBG structures in between the power planes to achieve properties such as multi-band noise suppression.

The topology of the EEBG structure embedded into the printed circuit board 10 for suppression of waves propagating along the parallel plates 24 and 26 of the wave guiding system created by the power bus planes of the printed circuit board may have alternative forms. For example, in the case of Electromagnetic Interference mitigation in the PCB 10, a ribbon 30, best shown in FIG. 4, consisting of the patches 22 with the via posts 18, (shown in FIGS. 3A and 3B) may be placed on the patch layer 14 along the perimeter 32 thereof in surrounding relationship with the source 34 of the radiation. If the internal circuits of the PCB 10 generate noise over the frequency within the band stop region of the EEBG ribbon 30, the presence of the ribbon 30 prevents waves generated within the PCB, from radiating from the edges of the board.

Referring once again to FIGS. 2A and 2B, such illustrate the lateral view and a prospective view respectively of the PCB employing this concept. In the example shown in FIG. 4, the patch board 14 of the size 6.5 cm×10 cm was fabricated on commercial FR4. The ribbon 30 of four rows of EEBG structures with the dimensions of the patches PS=5 mm×5 mm was positioned around the source of noise (excitation point) 34 located in the middle of the patch layer 14.

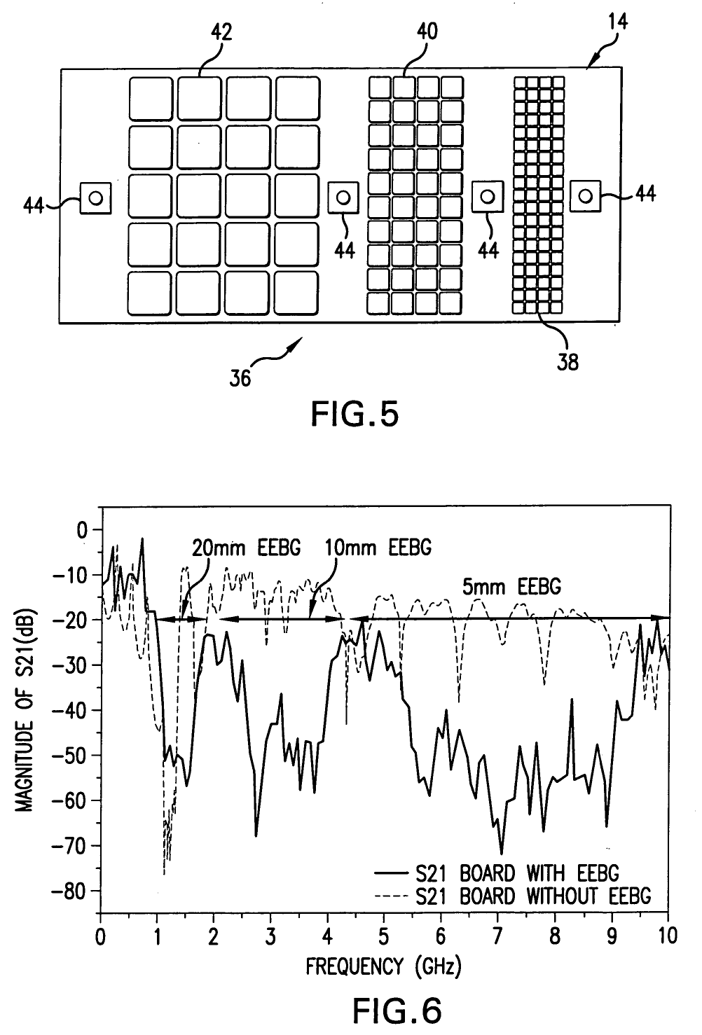

As shown in FIG. 5, a cascaded multiple band EEBG structure 36 is designed which is composed of independent periodic EEBG stages 38, 40, and 42 having different filtering parameters. The overall effect of cascading the EEBG stages would be a filter with a stop band equivalent to the superposition of the stop bands of individual EEBG stages. In this particular example, the board thickness, board material, via length, and also gap sizes have been maintained constant through the structures 38, 40, and 42, and the only parameter which has been changed is the patch size.

As can be seen in FIG. 5, the EEBG structure 38 is composed of patches with the patch size 5 mm×5 mm, while the EEBG structure 40 is composed of larger patches with dimensions 10 mm×10 mm, and the EEBG structure 42 is composed of the patches with dimensions 20 mm×20 mm. The EEBG structures 38, 40, and 42 have the equal number of rows, particularly four rows of the patches in this example.

It is understood by those skilled in the art that the bandwidth of each EEBG structure 38, 40, and 42 can be adjusted through changing other parameters of this EEBG structure, in combination with, through the addition of or instead of changing the dimensions of the patches 22. The resonance frequencies of the EEBG stages 38, 40 and 42 of the design shown in FIG. 5 with the dimensions of the patches as presented supra, are 5.93 GHz, 2.97 GHz, and 1.48 GHz, respectively.

The resonant frequency of each EEBG stage corresponds to the location of one of the zeros in the transfer function of the filter implemented as an EEBG structure. In the experimental set-up, the stripes (EEBG stages) 38, 40, and 42 may be fabricated on the FR4 laminates as two-layer boards with a unified ground plane behind the periodic structure. The top plate 12, best shown in FIG. 2B, is added and the entire assembly is pressed to remove the air from between the boards 12 and 14. The overall dimensions of the PCB in this particular example are 10 cm×30 cm.

Shown in FIG. 6 is a diagram illustrating experimental results of the fabricated structure of FIG. 5 where three cascaded EEBG stages represent the filter with ultrawide bandwidth filtering capabilities. In the diagram shown in FIG. 6, the magnitude of the S21 is measured between the farthest SMA connectors 44 shown in FIG. 5. For the structure shown in FIG. 5, with the patches of the dimensions 20 mm, 10 mm, and 5 mm, the gap size=0.4, via diameter=0.8 mm, board thickness=1.54 mm, and εᵣ=4.1, suppression of the noise in the wide frequency bandwidth is found. In the diagram of FIG. 6, the three designed bandgaps are located at 0.8 -1.8 GHz (for the EEBG 42 with PS=20 mm), 2.2-4.2 GHz (for the EEBG 40 with PS=10 mm), and 4.5-10 GHz (for the EEBG 38 with PS=5 mm). These EEBG structures have been designed without overlap to show the flexibility of the superposition effect. It will be understood by those skilled in the art, that the design parameters may be modified in a manner that the suppression bands overlap, expanding the suppression region to 800 MHz-10 GHz.

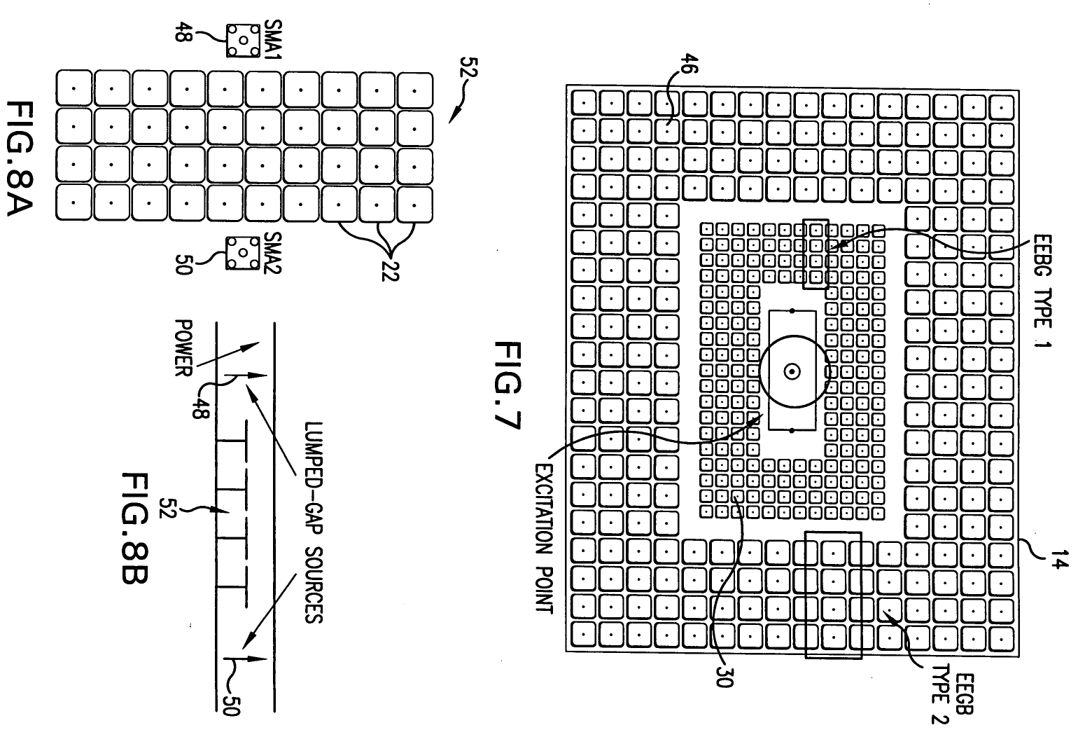

Using the ribbon design for the EEBG stage shown in FIG. 4, and the principles of cascading presented in FIG. 5, the widening of the suppression band gap can be accomplished by EEBG ribbon shaped stages of different filtering capabilities. FIG. 7 illustrates the concept of cascading two EEBG ribbon stages 30 and 46 on the patch layer 14. The ribbons 30 and 46 have different configurations defining the band gap of each ribbon. For example, the ribbon 30 includes four rows of patches with dimensions PS=5 mm, while the ribbon 46 has four rows of the patches with dimensions PS=10 mm. These two structures are cascaded for an ultrawide band suppression of radiation, thus preventing radiation escape through the edges of the PCB. The patch layer 14 shown in FIG. 7 has a size of 20.6 cm×16.6 cm, with the signal point (excitation point) 34 positioned at the center of the board and connected to the board through the SMA connector. In this configuration, the gap between the patches in both ribbons 30 and 46 is 0.4 mm. Cascading EEBG stages 30 and 46 is based on the same concept of cascading EEBG stages, as presented in FIG. 5, in order to achieve larger bandwidths (either pass band or stop band), multiple bands or larger attenuation.

In order to design EEBG structures embedded into a PCB for mitigation of the noise two methods have been successfully used which are S parameter simulations and dispersion diagram technique. FIGS. 8A and 8B show a diagram of the model used for an S parameter simulation. The model consists of two ports 48 and 50 and a 2D periodic EEBG structure 52 located between them. Since the presence of the EEBG structure 52 between the ports 48 and 50 prevents wave propagation between them within a frequency range corresponding to the bandwidth of the EEBG structure 52, the S21 parameter, (representative for the transfer power) may reflect the effect of the EEBG structure 52.

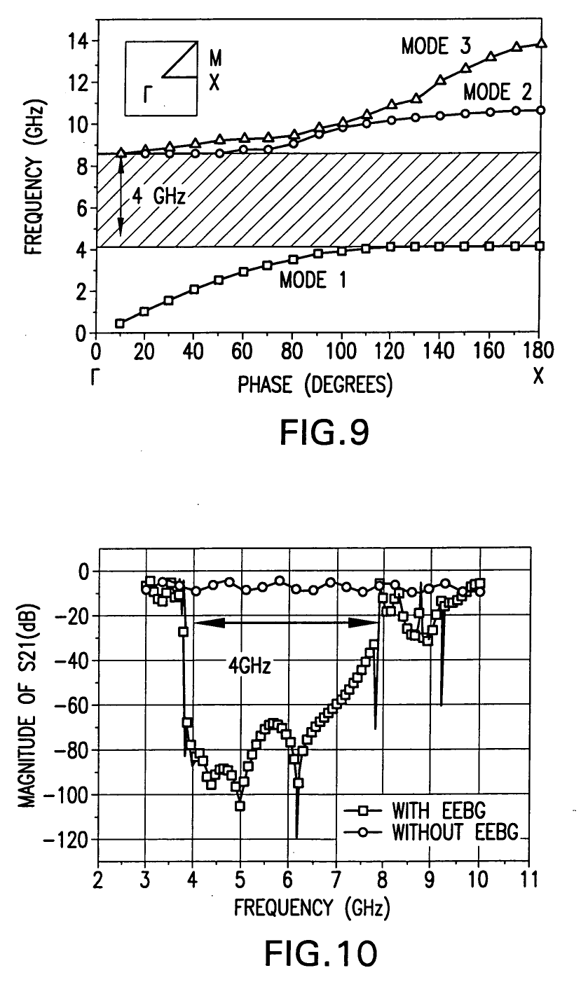

The other technique widely used for the study of periodic structures is the dispersion diagram. In a two-dimensional periodic structure in the X-Y plane, (due to the symmetry and periodicity) redundant propagation vectors may be grouped in a region known as Brillouin zone. By tracing kₓ and k_{y} (respectively the x and y components of the propagation constant) as variables, on the border of the irreducible zones using eigenmode simulation, the frequency of different propagation modes are calculated. For the patches of the EEBG structure 52, this region (Irreducible Brillouin Zone) is shown at the left upper corner of FIG. 9. In this diagram, the band gap is represented by the frequency range in which there is no propagating mode for any value of kₓ and k_{y}.

The S parameter deviation through full wave simulations and dispersion diagram extraction using periodic boundary conditions and eigenmode simulation (using a commercially purchasable CAD tool developed by Ansoft Company (HFSS)) has been found to be very effective in designing and implementing EEBG structures for suppressing noise in printed circuit boards. As an example of the type of results obtained using the S parameter simulations and dispersion diagrams, as shown in FIG. 9, the dispersion diagram for a periodic structure with patch size of 5 mm, via diameter of 0.8 mm, via length of 1.54 mm, board thichness of 3.8 mm, gap size of 0.4 mm, on commercial FR-4 is derived by simulation using HFSS. FIG. 10 shows the S21 parameter for the same structure when implemented as the model of FIG. 8. From both simulations, it is clear that the stop band lies approximately between 4 and 8 GHz.

The results of simulation of various EEBG structures are tabulated in Table 1.

TABLE 1

| | Low | High | |
|---|---|---|---|
| Patch Size | Frequency | Frequency | Bandwidth |
| (mm) | (GHz) | (GHz) | (GHz) |
| 4 | 5 | 11 | 6 |
| 5 | 4 | 8.1 | 4.1 |
| 6 | 3.5 | 7.5 | 4 |
| 8 | 2.5 | 5.3 | 2.8 |
| 10 | 2 | 4 | 2 |
| 12 | 1.7 | 3.3 | 1.6 |
| 15 | 1.35 | 2.45 | 1.1 |
| 17 | 1.2 | 2.3 | 1.1 |
| 20 | 1 | 1.8 | 0.8 |
| 25 | 0.66 | 1.46 | 0.8 |
| 30 | 0.63 | 1.18 | 0.55 |
| 40 | 0.45 | 0.87 | 0.42 |

By taking into account that the bandwidth of simulated structures is approximately two-thirds of the center frequency (66% fractional bandwidth), and that the switching noise power is mostly concentrated in frequencies below 6 GHz, EEBG structures may be designed in which the band stop region overlaps the desired suppression frequency. For lower center frequencies, EEBG structures with larger patches are needed however such may be impractical. This may be compensated by other EEBG structures, rather than the simple ones shown in FIGS. 3A and 3B, in order to obtain the same bandwidth or even multiple bandwidths with smaller periods (by changing patch sizes, distances between the patches and/or by modifying the other design parameters such as the substrate material).

The concept of radiation suppression from the PCBs using EEBG structures is effective and is applied to every couple of power bus layers (VDD-GND) rather than (GND-GND). Specifically, by adding EEBG structures between VDD-GND planes, radiation caused by simultaneous switching noise as well as noise generated by vias that pass through them is substantially suppressed. By adding EEBG structures between GND-GND or VDD-VDD points, radiation caused by noise generated by the vias that pass through them is suppressed as noise propagation since simultaneous switching noise does not exist in such pair of planes.

The EEBG structures used in the printed circuit boards in accordance with the present invention, are fabricated using commercial PCB manufacturing technology. In experimental stages in order to avoid the cost of blind vias, the printed circuit boards were constructed by compressing a double-sided PCB like the one shown in FIG. 4 and a single-sided PCB involving one of the power planes together as shown in FIG. 2B.

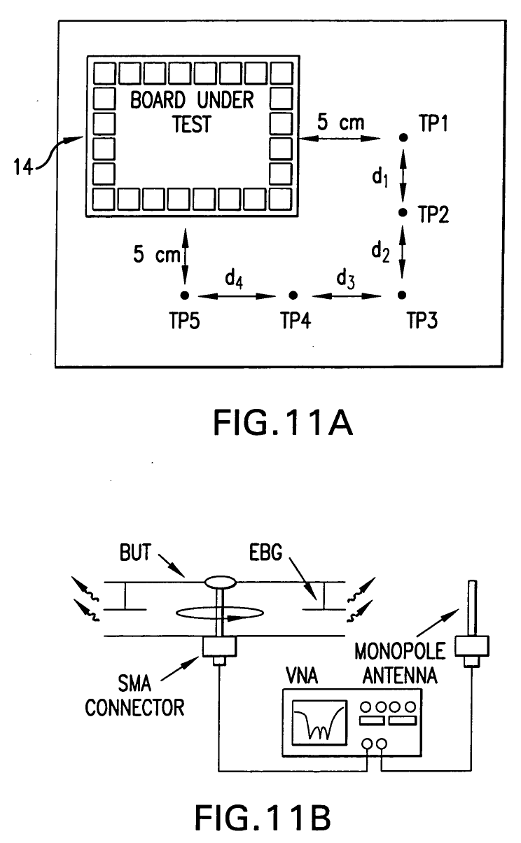

The designs shown in FIGS. 4 and 7 were used to test the proposed radiation suppression concept. The amount of radiation from the edges of the PCB was measured by measuring the scattering parameters (S21) as representative of the radiated power at various test points around the board as shown in FIG. 11A. The test points are chosen to show the omnidirectional suppression property of the proposed design. As shown in FIG. 11B, the signal was fed to the parallel plate environment through an SMA connector using a vector network analyzer (VNA). One of the ports was connected to the board under test (BUT) and the other one to a monopole antenna.

The area with no EEBG structure in FIGS. 4 and 7 was kept minimal in order to maximize the radiated energy received by a measuring receiving antenna. In a practical scenario, an EEBG structure with PS=5 mm and four rows of patches may be designed in a 2 cm wide ribbon around the PCB. For a 20 cm×10 cm board, this is 28% of the PCB area. The presence of the EEBG structure in this region implies some PCB design constraints for the PCB designers. Considering the fact that components may be located on top of the structure and that their power supplies can be connected directly to the patches, it is most likely that for practical applications the impact is minimal. In fact, the technique of the present invention does not impose an enlargement of the actual PCBs, but rather the EEBG structures are being implanted into the border side of an already designed PCB with appropriate modifications. It is emphasized that although the concept of radiation suppression using EEBG structures is general, rectangular patch sizes larger than 5 mm have not to this point been found practical. Thus, more complex combination EEBG structures need to be used for low frequencies.

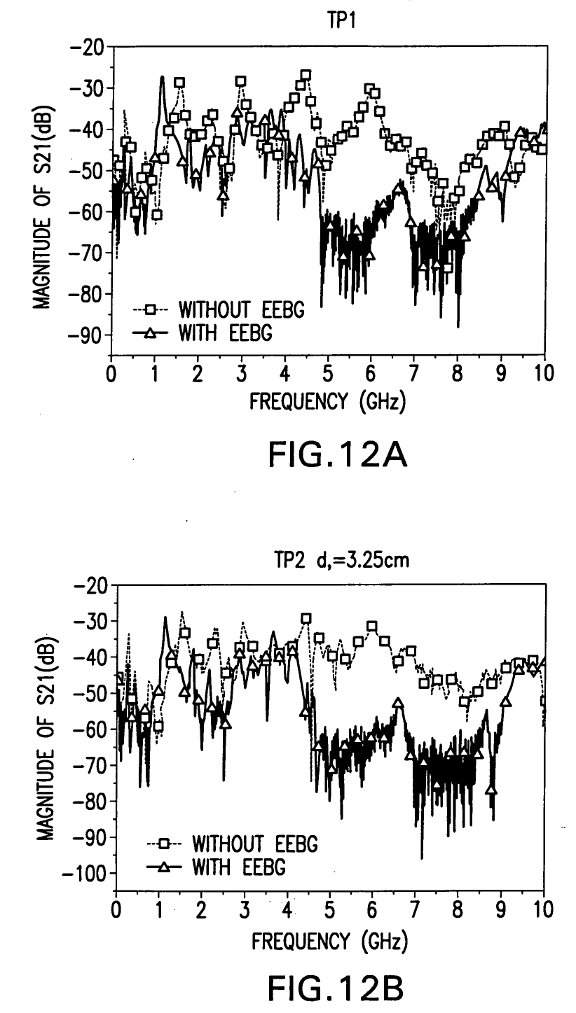

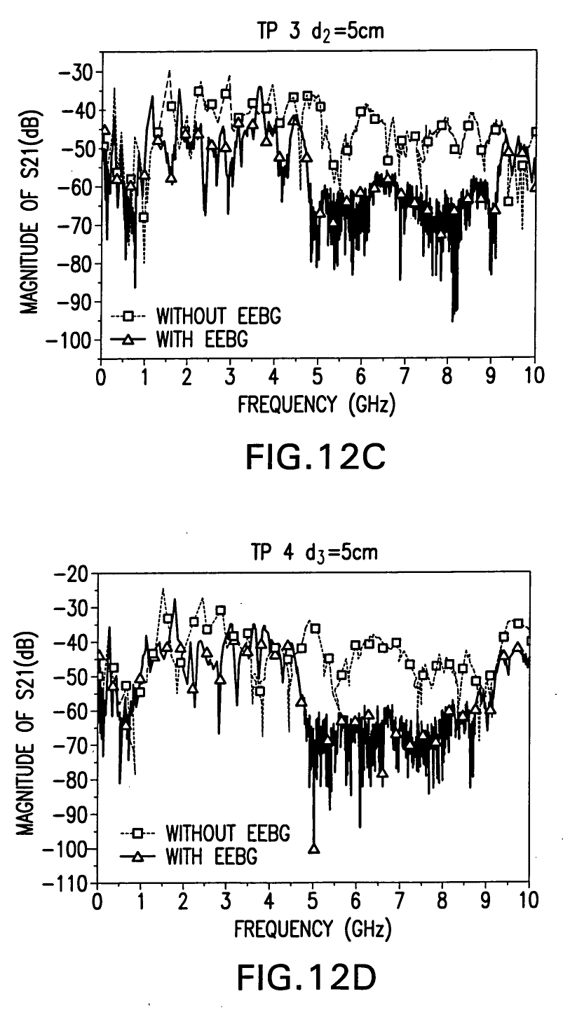

FIGS. 12A-12D show the results of these measurements. A wide gap from 4 GHz to 10 GHz (as predicted from the simulations shown in Table 1) shows an average suppression of 30 DB within the gap in comparison to the case without the EEBG. Higher attenuations than predicted at higher frequencies is likely due to dissipation in the FR4 substrate and to higher, but not significant, band gaps created by the structure. The plot of measured S21 for a reference board without the EEBG structure is also included in the diagrams shown in FIGS. 12A-12D for comparison.

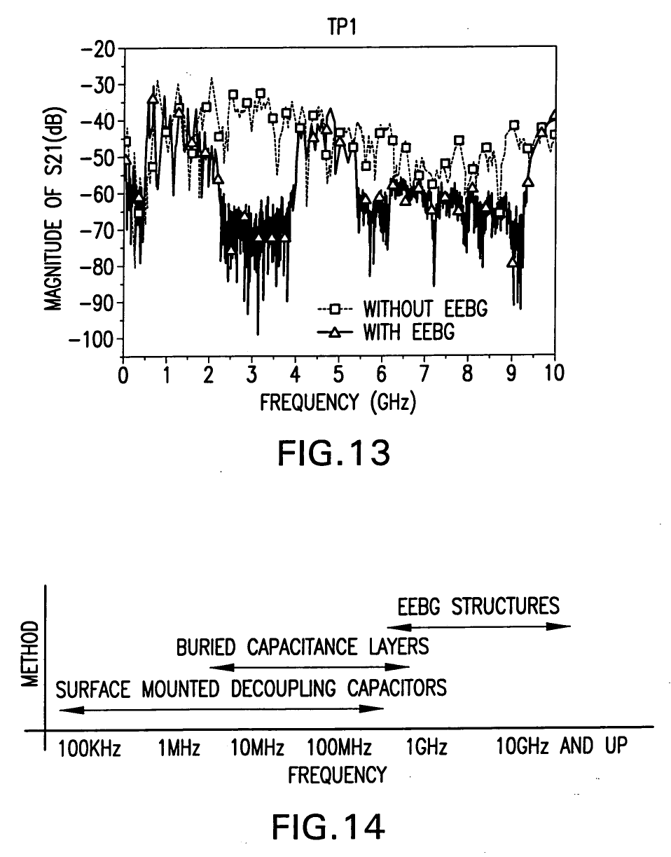

FIG. 13 shows the measured S21 response for the configuration shown in FIG. 7 where the ribbons 30 and 46 are cascaded. The S21 is measured at the test point 1 shown in FIG. 11A. Due to the omnidirectional suppression property of the EEBG structures, measurements as to other test points shown in FIG. 11A reflect the same radiation suppression behavior. This experimental result shows that an additional gap between 2 GHz and 4 GHz is introduced by the added structure with the period of 10.4 mm. This property is especially relevant to cases in which the suppression of a fundamental frequency is as important as the suppression of the harmonic of that frequency. As illustrated by the diagram shown in FIG. 13, the design shown in FIG. 7 is capable of suppressing not only a noise at 3 GHz but also its second and third harmonics at 6 GHz and 9 GHz, thus creating ultrawide band suppression radiation from printed circuit boards employing such a design.

In multilayer PCBs, the power and ground planes as well as signal layers act as radiating microstrip page antennas, where radiation is caused by fringing electric fields at board edges. The present invention is an effective method for suppressing PCB radiation from their power bus as well as signal layers over an ultrawide range of frequency by using metallo-dielectric electromagnetic bandgap structures, also referred to herein as high impedance surfaces.

More specifically, the present invention focuses on the suppression of radiation from parallel-plate bus structures in high speed printed circuit boards caused by switching noise, such as simultaneous switching noise (SSN), also known as Delta-I noise or ground bounce. This noise consists of unwanted voltage fluctuations of the power bus of a PCB due to the resonance of parallel-plate wave guiding system created by the power bus planes.

The techniques introduced in the present invention are not limited to the suppression of switching noise and may be extended to any wave propagation between the plates of the power bus and signal layers. Simulation in the experimental results proves the effectiveness of the method of the present invention in suppressing radiation from printed circuit boards in a range of frequency over which the conventional methods are not effective.

In FIG. 14, the frequency range is illustrated for different radiation suppression methods. Although as shown in FIG. 14, the simple EEBG structures presented in the present invention are targeting the 0.5-10 GHz range, therefore pushing the limit of previous methodologies, the scope of the present invention is not limited to this range of frequencies and the novel concept in question extends beyond this frequency range.

In view of the ongoing miniaturization of electronic systems, the implementation of the principles of the present invention requires the availability of miniaturized EEBG structures with appropriate patch sizes, although the concept introduced in this invention can be generally applied regardless of the size of the EEBG structures. If wideband radiation reduction from hundreds of MHz to few GHz is needed, a combination of different methods may be used.

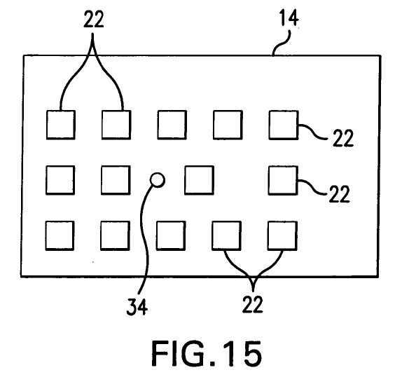

Ultrawide band suppression of the radiation is achieved by cascading different configurations of EEBGs. In addition to the concentric ribbon-like EEBG stages extending along the perimeter of the printed circuit boards, the topology may include the EEBG structures having checkerboard design shown in FIG. 15.

The technique introduced in the present Patent Application also targets isolation applications as well. The isolation between different portions of circuits (such as analog and digital parts of a circuit) can be attained by using EEBG structures and the techniques proposed in this invention.

The significance of ultrawide band suppression lies in the fact that the cascaded EEBG structures provide a practical way to suppress radiation not only in the frequency of the noise but also to its harmonics. PCB prototypes were designs, developed and tested showing unprecedented level of EMI reduction of an ultrawide band frequency which can encompass the clock frequency and its immediate harmonics.

Although this invention has been described in connection with specific forms and embodiments thereof, it will be appreciated that various modifications other than those discussed may be resorted to without departing from the spirit or scope of the invention as defined in the appended Claims. For example, equivalent elements may be substituted for those specifically shown and described. Certain features may be used independently of other features, and in certain cases, particular locations of elements may be reversed or interposed, all without departing from the spirit or the scope of the invention as defined in the appended Claims.

1. A method for mitigation of electromagnetic radiation generated in a multi-layer structure having at least two conductive planes, the method comprising the steps of:
forming at least one Electromagnetic Bandgap (EBG) stage, and
embedding said at least one EBG stage in the multi-layer structure between said conductive planes thereof at a predetermined location relative to a source of the electromagnetic radiation.

2. The method of claim 1, further comprising the step of:
positioning said at least one EBG stage in surrounding relationship with said source of radiation.

3. The method of claim 1, further comprising the steps of:
positioning said at least one EBG stage along the perimeter of said multi-layer structure.

4. The method of claim 1, further comprising the steps of:
forming at least a pair of said EBG stages, each having a distinct stop band filtering capability, and
cascading said EBG stages to suppress the electromagnetic radiation over a wide bandwidth.

5. The method of claim 4, wherein the electromagnetic radiation is associated with a switching noise.

6. The method of claim 1, wherein said conductive planes are power planes.

7. The method of claim 1, wherein said conductive planes include signal layers.

8. The method of claim 1, further comprising the step of:
forming said at least one EBG stage as an independent structure comprising at least a pair of conductive patches, each said patch having a respective via post extending from said patch substantially at the center thereof.

9. The method of claim 8, wherein each said patch is of a rectangular shape.

10. The method of claim 8, further comprising the step of:
coupling an end of each said respective via to one of said pair of conductive planes of said multi-layer structure.

11. The method of claim 8, further comprising the steps of:
forming a ribbon of a plurality of said patches, and
positioning said ribbon along the perimeter of said multi-layer structure.

12. The method of claim 11, further comprising the steps of:
forming at least a pair of said ribbons, each said ribbon having a distinct stop band width, and
cascading said ribbons.

13. The method of claim 12, further comprising the step of:
positioning said at least pair of said ribbons along said perimeter of said multi-layer structure in concentrical relationship each to the other.

14. The method of claim 1, further comprising a plurality of said EBG stages arranged in a checkerboard pattern around said source of electromagnetic radiation.

15. The method of claim 1, wherein said multi-layer structure is a printed circuit board (PCB).

16. The method of claim 15, wherein said PCB includes at least a first board having one of said at least two conductive planes and at least a second board having another of said at least two conductive planes, the method further comprising the steps of:
securing said at least one EBG stage to said at least one first board in contact with said one of said conductive planes, and
attaching said at least second board to said at least first board, to sandwich said at least one EBG stage between said conductive planes.

17. A printed circuit board (PCB) with electromagnetic noise mitigation, comprising:
at least a pair of conductive planes, and
at least one Electromagnetic Bandgap (EBG) stage embedded in said PCB between said conductive planes at a predetermined location relative to a source of the electromagnetic noise and coupled to one of said conductive planes.

18. The PCB of claim 17, wherein said at least one EBG stage is formed as a structure including a plurality of conductive patches each having a respective via post extending from said patch substantially at the center thereof.

19. The PCB of claim 17, further comprising at least a pair of cascaded EBG stages, each having a distinct stop band filtering capability.

20. The PCB of claim 19, wherein said cascaded EBG stages suppress noise in said PCB over an ultra-wide bandwidth.

21. The PCB of claim 18, wherein said at least one EBG stage is formed as a ribbon positioned along the perimeter of said PCB.

22. The PCB of claim 21, further comprising at least a pair of cascaded said ribbons extending in said PCB in concentric relation each to the other along the perimeter of said PCB.

23. The PCB of claim 17, wherein said conductive planes are power planes.

24. The PCB of claim 17, wherein said conductive planes are signal layers.

25. The PCB of claim 18, wherein said patches are of rectangular shape.

26. The PCB of claim 18, wherein said at least one EBG stage includes a plurality of said patches arranged in checkerboard fashion around said source of noise.

27. The PCB of claim 17, wherein said noise is a switching noise.

28. The PCB of claim 17, wherein said noise is an electromagnetic radiation generated in said PCB.

29. The PCB of claim 17, further comprising:
at least a first board including one of said at least a pair of conductive planes and at least a second board including another of said at least a pair of conductive planes,
said at least one EBG stage being secured to said first board in contact with said one of said conductive planes, and said second board being attached to said first board to sandwich said at least one EBG structure therebetween.

30. A multi-layer structure with noise suppression over an ultra-wide bandwidth, comprising:
at least a pair of conductive planes displaced one from another, and
at least a pair of cascaded Electromagnetic Bandgap (EBG) stages, each having a distinct stop band filtering capability, said EBG stages being embedded in said multi-layer structure between said conductive planes.

31. The multi-layer structure of claim 30, wherein each of said EBG stages includes a plurality of conductive patches each having a respective via post extending from said each patch.

32. The multi-layer structure of claim 27, wherein said pair of cascaded EBG stages are positioned in concentrical relationship each to the other along the perimeter of said multi-layer structure.
